(19) United States
(12) Patent Application Publication
(10) Pub. No.: US 2004/0249863 A1
(43) Pub. Date: Dec. 9, 2004

(54) Data conversion apparatus, data conversion system, and data conversion program

(75) Inventor: Takuya Kawamura, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/851,315

(22) Filed: May 24, 2004

(30) Foreign Application Priority Data
Jun. 3, 2003 (JP) 2003-157532

(51) Int. Cl. G06F 17/00

(52) U.S. Cl. 707/104.1

(57) ABSTRACT

A data conversion apparatus including a plurality of electronic data storage units storing electronic data with a proper attribute, a storage command unit configured to instruct to store electronic data to be stored in one of the plurality of electronic data storage units, an attribute detection unit configured to detect an attribute of the electronic data to be stored in the electronic data storage unit preassigned the attribute instructed by the storage command unit, a format conversion unit configured to convert a format of the electronic data to be stored so as to fit a format for the attribute detected by the attribute detection unit if the attribute of the electronic data to be stored differs from the attribute detected by the attribute detection unit, and a storage control unit configured to store the electronic data converted by the format conversion unit in the electronic data storage unit as a storage destination.

### BACKGROUND OF THE INVENTION

1. Field of the Invention

This invention relates to a data conversion apparatus, a data conversion system, and a data conversion program for storing electronic data in any of a plurality of electronic data storage units.

2. Background Art

An electronic information machine including an operation system typified by Windows®, Linux®, etc., generally includes a user interface for copying electronic data retained in the electronic information machine to another data, and for providing the copy function for a user using the electronic information machine.

The copy function can be abstracted as description of copy (A, B) as a function. A denotes original data and B denotes copied data. As copy (A, B) is executed, B is created from A.

As the user interface for providing the copy function, for example, the operating system Windows of Microsoft® provides an application including a command line user interface called a command prompt and an application including a graphical user interface called Explorer.

To use the command prompt, for example, the user describes “copy c:/folder1/test1.txt c:/folder2/test2.txt”, whereby a copy of a file test1.txt existing in a folder folder1 in a c drive is created as a file test2.txt under a folder folder2 in the c drive. On the other hand, to use Explorer, the user selects one file, drags and drops the file while pressing a “Ctrl” key, whereby the file can be copied.

By the way, an art for copying or moving data in a drag-and-drop manner between different record media is proposed. (See JP2002-25182(kokai).) Inventors of JP2002-25182(kokai) bear in mind only copying and moving between the internal hard disk drive of a PC and an external record unit such as a CD recorder, and they do not bear in mind copying and moving between the folders in the same record unit.

JP2002-25182 (kokai) discloses a format association table for associating media with each other, and resolution conversion of data upon copying or moving is executed based on the resolution information registered in the table.

For a user aiming at programming, various functions for copying a file are provided as a programming language. For example, a function of copy (A, B, Option) is abstractly provided, and to create B from A an instruction can also be given so as to follow the rule described in “Option.” In this case, for example, if a rule of “converting a JPEG file into a bitmap file” is specified as “Option”, when A is a JEPG file, a bitmap file may be able to be created as B.

On the other hand, an application including a graphical user interface typified by Explorer enables the user to copy a file in a drag-and-drop manner for providing the user a simple operationality. However, it is also difficult under present circumstances to “convert a JPEG file into a bitmap file”, for example, in the drag-and-drop copy operation.

In JP2002-25182(kokai), the table is provided in each folder, and as a number of the folders increases, a number of the tables increases. A capacity of hard disk tends to increase year after year and a number of folders also increases accordingly. Therefore, it is feared that the number of the tables may become enormous, and it takes time in copy or move process.

It is therefore an object of the invention to provide a data conversion apparatus, a data conversion system, and a data conversion program for saving the user's trouble to operate the apparatus as much as possible to store electronic data in specific electronic data storage unit with attribute specification.

### SUMMARY OF THE INVENTION

To the end, according to an aspect of the invention, there is provided a data conversion apparatus including a plurality of electronic data storage units each of which stores electronic data having a proper attribute, a storage command unit configured to instruct to store electronic data to be stored in one of the plurality of electronic data storage unit, an attribute detection unit configured to detect an attribute of the electronic data to be stored in the electronic data storage unit, the attribute being instructed by the storage command unit configured to be preassigned to the electronic data storage unit as a storage destination, a format conversion unit configured to convert a format of the electronic data to be stored so as to fit a format for the attribute detected by the attribute detection unit if the attribute of the electronic data to be stored differs from the attribute detected by the attribute detection unit, and a storage control unit configured to store the electronic data converted by the format conversion unit in the electronic data storage unit as the storage destination.

Further, according to another aspect of the invention, there is provided a data conversion apparatus including a plurality of electronic data storage units, each of which stores electronic data having a proper attribute, a storage command unit configured to instruct to store electronic data to be stored in one of the plurality of electronic data storage units, a storage control unit configured to store the electronic data instructed by the storage command unit in the electronic data storage unit as the storage destination, an attribute detection unit configured to detect an attribute of the electronic data to be stored in the specific electronic data storage unit storing the electronic data, the attribute being instructed by the storage command unit configured to be preassigned to the electronic data storage unit, and a format conversion unit configured to convert the electronic data to be stored in accordance with the attribute detected by the attribute detection unit and the command given by the storage command unit.

According to yet another aspect of the invention, there is provided a data conversion apparatus including a plurality of electronic data storage units each of which stores electronic data having a proper attribute, a storage command unit configured to instruct to store electronic data to be stored in one of the plurality of electronic data storage units, an attribute detection unit configured to detect an attribute of the electronic data to be stored in the electronic data storage unit, the attribute being instructed by the storage command unit configured to be preassigned to the electronic data storage unit as a storage destination, a format conversion unit configured to convert a format of the electronic data to be stored so as to fit a format for the attribute detected by the attribute detection unit if the attribute of the electronic data to be stored differs from the attribute detected by the attribute detection unit, and a storage control unit configured to store the electronic data converted by the format conversion unit in the electronic data storage unit as the storage destination. Preferably, the electronic data storage unit is a folder or a directory logically created by an operating system.

According to still yet another aspect of the invention, there is provided a data conversion program including instructing to store electronic data to be stored in one of a plurality of electronic data storage units each of which stores electronic data having a proper attribute, detecting an attribute of the electronic data to be stored in the electronic data storage unit, the attribute being instructed to be preassigned to the electronic data storage unit as a storage destination, converting a format of the electronic data to be stored to fit a format for the detected attribute if the attribute of the electronic data to be stored differs from the detected attribute, and storing the electronic data subjected to the conversion in the electronic data storage unit as the storage destination.

According to still another aspect of the invention, there is provided a data conversion program including instructing to store electronic data to be stored in one of a plurality of electronic data storage units each of which stores electronic data having a proper attribute, storing the instructed electronic data in the electronic data storage unit as a storage destination, detecting an attribute of the electronic data to be stored in the specific electronic data storage unit, the attribute being preassigned to the electronic data storage unit storing the instructed electronic data, and converting the electronic data to be stored in accordance with the detected attribute and the instruction.

According to embodiments of the present invention, the format of the electronic data to be stored is automatically converted so as to be fitted for the attributes of the electronic data storage unit configured to store the electronic data, so that the format conversion of the electronic data can be executed while the user is not aware of the format conversion. In a data conversion apparatus in the related art as JP2002-25182(kokai), format attributes of image files are determined and fixed according to types of storage media. According to an aspect of the invention, a data conversion apparatus has a flexibility to specify format attributes of image files to respective folders in the same medium.

### BRIEF DESCRIPTION OF THE DRAWINGS

The present invention may be more readily described with reference to the accompanying drawings:

FIG. 1 is a block diagram to show the schematic configuration of a data conversion apparatus according to a first embodiment of the invention;

FIG. 2 is a drawing to show an example of an operation screen of a GUI section 1;

FIG. 3 is a flowchart to show a procedure example of the data conversion apparatus in FIG. 1;

FIG. 4 is a block diagram to show the schematic configuration of a data conversion apparatus according to a second embodiment of the invention;

FIG. 5 is a flowchart to show a procedure example of the data conversion apparatus in FIG. 4;

FIG. 6 is a block diagram to show the schematic configuration of a data conversion apparatus according to a third embodiment of the invention;

FIG. 7 is a flowchart to show a procedure example of the data conversion apparatus in FIG. 6;

FIG. 8 is a block diagram to show the schematic configuration of a data conversion apparatus according to a fourth embodiment of the invention;

FIG. 9 is a flowchart to show a procedure example of the data conversion apparatus in FIG. 8;

FIG. 10 is a block diagram to show the schematic configuration of a data conversion apparatus according to a fifth embodiment of the invention;

FIG. 11 is a drawing to show an example of a management table;

FIG. 12 is a drawing to show an example of a user interface provided by a folder attribute management section 11 for the user to set attributes of folders;

FIG. 13 is a block diagram to show the schematic configuration of a data conversion system according to a sixth embodiment of the invention; and

FIG. 14 is a block diagram to show the schematic configuration of a data conversion system according to a seventh embodiment of the invention.

### DETAILED DESCRIPTION OF THE PREFERRED EMBODIMENTS

### MODE FOR CARRYING OUT THE INVENTION

A data conversion apparatus, a data conversion system, and a data conversion program according to the invention will be discussed specifically with reference to the accompanying drawings.

### First Embodiment

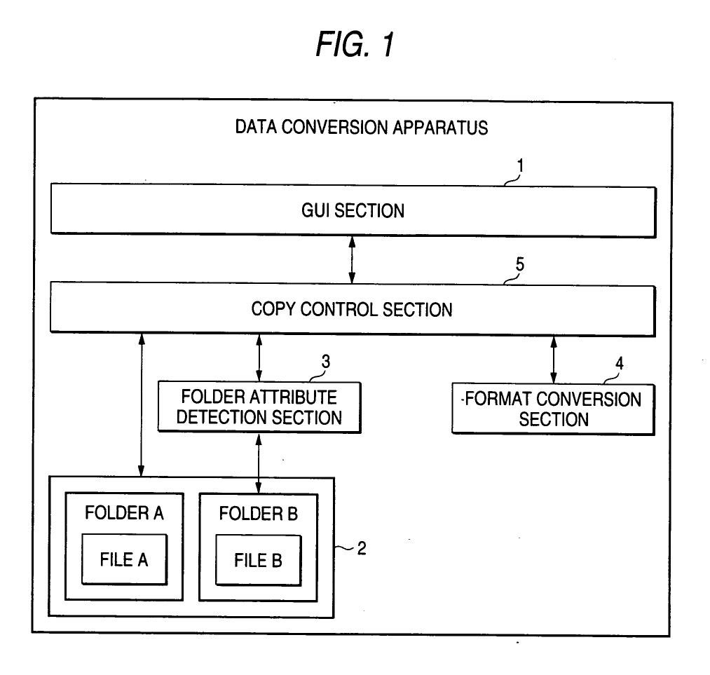

FIG. 1 is a block diagram to show a schematic configuration of a data conversion apparatus according to a first embodiment of the invention. The data conversion apparatus in FIG. 1 is incorporated in an electronic information machine such as-a personal computer (PC). The data conversion apparatus in FIG. 1 may be implemented as a hardware or software, or a part of the data conversion apparatus may be implemented as a hardware and the remaining parts may be implemented as a software.

The data conversion apparatus in FIG. 1 includes a graphical user interface section (GUI section) 1 for copying a file, storage unit 2 for storing electronic data for each folder, a folder attribute detection section 3 for detecting an attribute of each folder in the storage unit 2, a format conversion section 4 for executing a format conversion of electronic data, and a copy control section 5 for controlling the folder attribute detection section 3 and the format conversion section 4 when the electronic data is copied.

Assuming a PC using Windows® of Microsoft®, for example, as an operating system (OS), the GUI section 1 is an operation screen of Explorer™ as a standard equipment of the OS. The storage unit 2 is a storage unit of an internal or external hard disk drive (HDD) of the PC, a memory card, etc.

FIG. 1 omits a component in the electronic information machine irrelevant to the description of the invention (for example, a CPU, a keyboard, etc.).

In the description that follows, copying of image data using the data conversion apparatus in FIG. 1 is taken as an example, but the invention can also be applied when electronic data other than image data is stored in the storage unit 2.

A plurality of folders (also called directories) for storing electronic data having proper attributes for each are logically created in the storage unit 2. The folders are created by a function of the OS.

The GUI section 1 has a function of displaying a user operation screen, a function of displaying information on the folders and files retained in the storage unit 2, and a function of executing a process corresponding to an operation by the user of copying a file or the like on the operation screen.

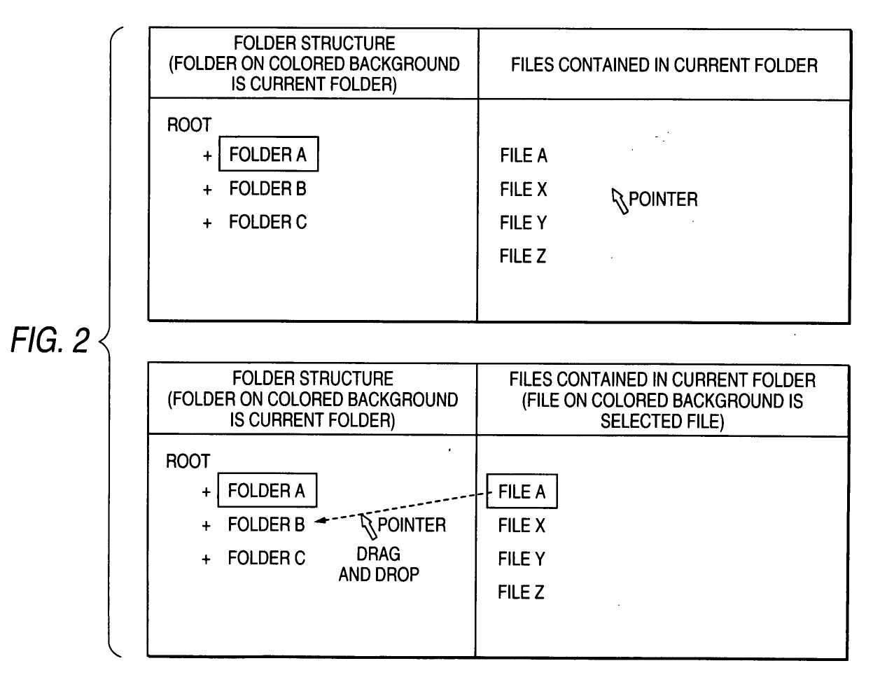

FIG. 2 is a drawing to show an example of the operation screen of the GUI section 1. The user operates a pointer displayed in FIG. 2 with a pointing device such as a mouse, selects file A, for example, then drags and drops the file A into folder B, whereby the file can be moved or copied. In the description of the embodiment, copying of a file to another folder using drag-and-drop is taken as an example.

An electronic information machine in a related art has only the GUI section 1 and the storage unit 2 in the configuration in FIG. 1 and performs file copy operation, etc., using a copy function copy (A, B) provided by the OS.

Here, the copy source file is set in the copy function argument A and the copy destination file is set in the argument B. Accordingly, the copy source file is copied to the copy destination.

For example, if the user selects the file A shown in FIG. 2 on the operation screen and drags and drops the file A into the folder B, the GUI section 1 executes copy(root/folder A/file A, root/folder B/file A). Consequently, the file A is copied into the folder B logically managed in the storage unit 2.

More particularly, when the GUI section 1 executes copy(root/folder A/file A, root/folder B/file B), the file A in the folder A connected to the top layer (root) of the folders logically managed in the storage unit 2 is copied to the file B in the folder B connected to the same root. Here, the file A and file B contain the same data if they differ in name.

In contrast, the copy control section 5 in the embodiment provides a unique copy function copy′ (A, B) in addition to copy(A, B). The arguments A and B of copy′ (A, B) are the same as the arguments of copy (A, B) and the user can perform copy operation without being aware of a difference between the functions on operation.

For example, if the user selects the file A shown in FIG. 2, drags and drops the file A into the folder B, the GUI section 1 executes copy′ (root/folder A/file A, root/folder B/file B).

In the embodiment, the copy destination file is denoted as the file B for convenience. However, as a general copy operation copies the same file as the file A, the file B is essentially the file A. In the description that follows, copy source information “root/folder A/file A” is denoted as “copy source A” and copy destination information “root/folder B/file B” is denoted as “copy destination B.”

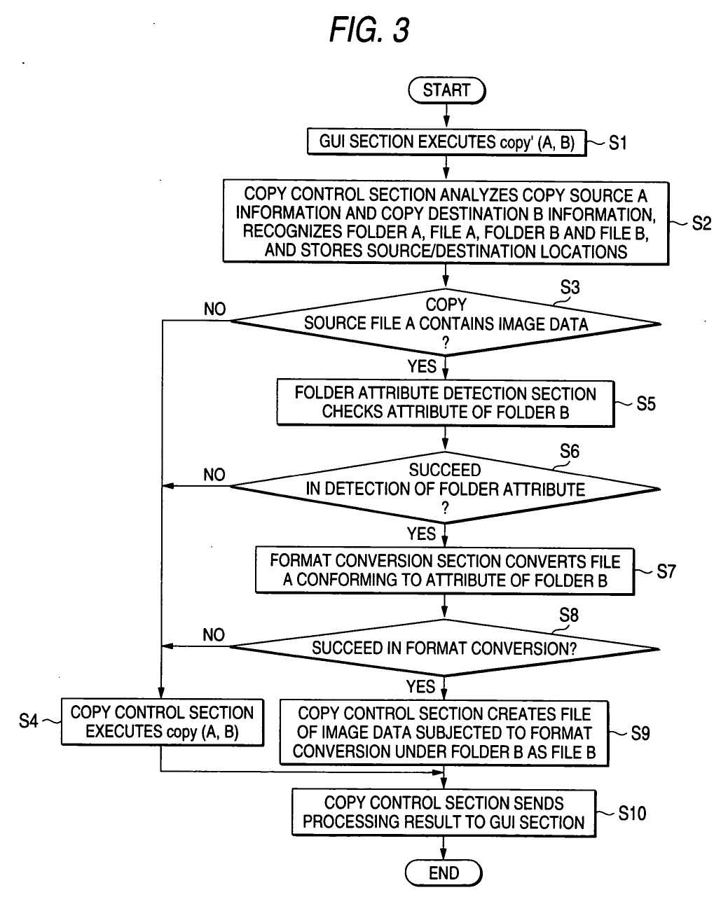

FIG. 3 is a flowchart to show a procedure example of the data conversion apparatus in FIG. 1. To begin with, when the GUI section 1 executes copy′ (copy source A, copy destination B) (step S1), the copy control section 5 analyzes information on “copy source A” and information on “copy destination B”, recognizes folder A, file A, folder B, and file B, and stores the source/destination locations (step S2). At this time, for “copy destination B”, file B, a file name created at the copy destination, and folder B, a copy destination folder name under which the file is created, are separately recognized.

Next, the folder attribute detection section 3 detects an attribute of the file A, and for “copy source A”, determines whether or not the file A containing copy source data is a file containing image data (step S3).

For example, the pixel size of the height and width of an image will be discussed as a specific example of an attribute concerning the format of image data. In this case, for example, the folder attribute detection section 3 outputs information of “pixel size: 640×480” to the copy control section 5. In the embodiment, for the attribute concerning the format of image data added to the folder, the folder name is checked and if the folder name is described in a form representing the pixel size, for example, like “640_{—}480”, the folder attribute detection section 3 can detect the attribute concerning the image data format.

If it is determined at step S3 that the file does not contain image data, a predetermined error handling is performed. In the error handling, copy(copy source A, copy destination B) is executed (step S4) and the file B is created in the folder B in the storage unit 2 and then the execution result is sent to the GUI section 1 and the process is terminated.

On the other hand, if it is determined at step S3 that the file contains image data, the folder attribute detection section 3 detects the attribute of the folder B (step S5) and it is determined whether or not the folder attribute detection section 3 has succeeded in detecting the folder attribute (step S6). If it has failed the detection of the folder attribute, the process goes to step S4; if it has succeeded in the detection, the format conversion section 4 converts the file A conforming to the attribute of the folder B (step S7).

Next, it is determined whether or not the format conversion section 4 has succeeded in the format conversion (step S8). If it has failed the format conversion, the process goes to step S4; if it has succeeded in the format conversion, the copy control section 5 stores the image data subjected to the format conversion in the folder B as the file B (step S9).

Upon completion of the process at step S4 or S9, the copy control section 5 sends a process result to the GUI section 1 (step S10).

Thus, in the first embodiment, when the GUI section 1 executes the copy function, the format conversion of the copy source image data is executed conforming to the attribute of the copy destination folder, so that the format conversion of the image data can be automatically executed while the user is not aware of the format conversion, and the work load on the user is lightened. A fear of erroneously storing image data in a different format in the folder with a predetermined attribute is eliminated, and file management can be executed correctly.

In the embodiment, the pixel size has been described as an example of the image data format, the format conversion section 4 may execute a format conversion other than the pixel size, such as a type of image data, a resolution of image data, height and width of image data, a number of colors of image data, and an encoding of image data.

### Second Embodiment

A second embodiment of the invention is intended for lightening the process load as compared with the first embodiment.

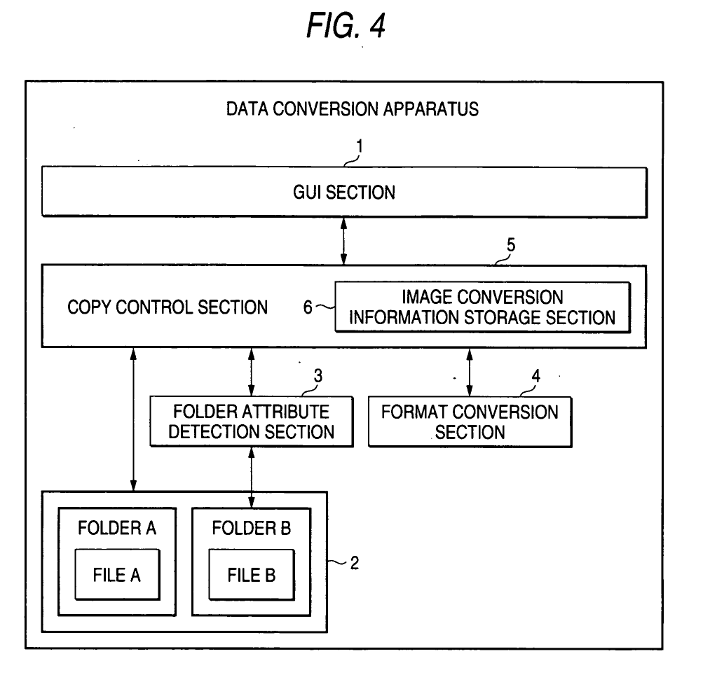

FIG. 4 is a block diagram to show a schematic configuration of a data conversion apparatus according to the second embodiment of the invention. A component identical with or similar to that in FIG. 1 is denoted by the same reference numeral in FIG. 4, and the description to follow centers around a difference between the first and second embodiments.

The data conversion apparatus in FIG. 4 has an image conversion information storage section 6 for storing attribute information of an encoding, a pixel size, etc., that can be converted by a format conversion section 4 in a copy control section 5.

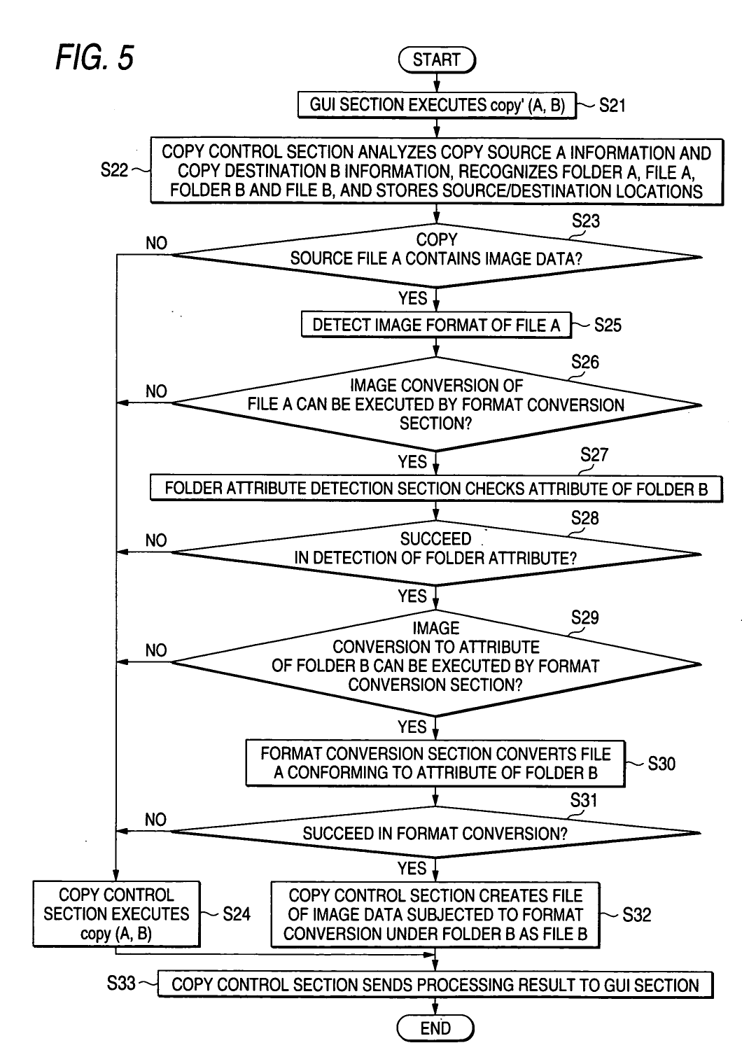

FIG. 5 is a flowchart to show a procedure example of the data conversion apparatus in FIG. 4. The flowchart of FIG. 5 is provided by adding steps S25, S26, and S29 to the flowchart of FIG. 3. The description to follow centers around different process from FIG. 3.

If it is determined at step S23 that copy source file A contains image data, then a folder attribute detection section 3 detects an image format of the file A (step S25). Next, it is determined whether or not an image conversion of the file A can be executed by the format conversion section 4 (step S26)

The copy control section 5 has a function of detecting the encoding, the pixel size, etc., of an image data format, and compares the information concerning the detected format with the information that can be converted in the format conversion section 4, stored in the image conversion information storage section 6. If it is determined that it is impossible to convert either of the encoding and the pixel size in the format conversion section 4, the copy control section 5 performs error handling (step S24) as with the case where it is determined at step S23 that the file does not contain image data.

Next, the folder attribute detection section 3 detects an attribute of the folder B (step S27). To detect the attribute of the folder B, the folder attribute detection section 3 detects information concerning both the encoding and the pixel size. In this case, for example, the folder attribute detection section 3 outputs information of “JPEG, 640×480” to the copy control section 5. As an attribute concerning the format of image data added to the folder, in the embodiment, a folder name is checked and if the folder name is described in a predetermined form so as to represent the encoding and the pixel size, for example, like “JPEG_{—}640_{—}480”, the attribute concerning the image data format can be detected.

When the attribute concerning the image data format is input from the folder attribute detection section 3, the copy control section 5 checks values of the encoding and the pixel size which are the folder attribute values, and determines whether or not either of the encoding and the pixel size can be converted in the format conversion section 4 (step S29). If it is determined at step S29 that conversion is impossible, the copy control section 5 performs an error handling (step S24) as with the case where the file A does not contain image data.

When information on “copy source A” and the attribute concerning the image data format are input from the copy control section 5, the format conversion section 4 converts the file A of “copy source A” as the image data format in accordance with the input attribute values. For example, if the file A is a bitmap file and contains image data of 1600 pixels×1200 pixels and the attribute value “JPEG, 640×480” is input, the encoding of the file A is converted into JPEG and the pixel size of the file A is converted into 640 pixels×480 pixels.

After this, steps S31 to S33 similar to steps S9 to S11 in the first embodiment are executed.

Thus, in the second embodiment, it is checked before the copy process whether or not the image conversion of the copy source file A can be executed and whether or not the image conversion conforming to the attribute of the copy destination folder B can be executed, so that a fruitless process executed by the folder attribute detection section 3 and the format conversion section 4 is eliminated, and a whole process amount of the data conversion apparatus can be decreased.

### Third Embodiment

In a third embodiment of the invention, image data converted by a format conversion section 4 is stored in a copy control section 5 so that the format conversion section 4 does not repeat image conversion of the same image data.

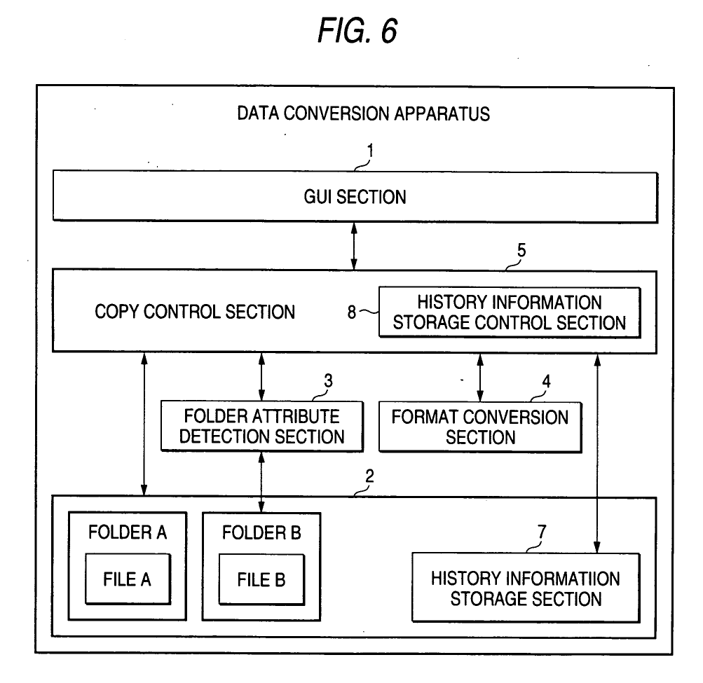

FIG. 6 is a block diagram to show a schematic configuration of a data conversion apparatus according to the third embodiment of the invention. A component identical with or similar to that in FIG. 1 is denoted by the same reference numeral in FIG. 6, and the description to follow centers around a difference between the first and third embodiments.

The data conversion apparatus in FIG. 6 has a history information storage section 7 provided in a storage unit 2 for storing image conversion history information and the converted image data, and a history information storage control section 8 provided in the copy control section 5 for performing storage control of the history information storage section 7.

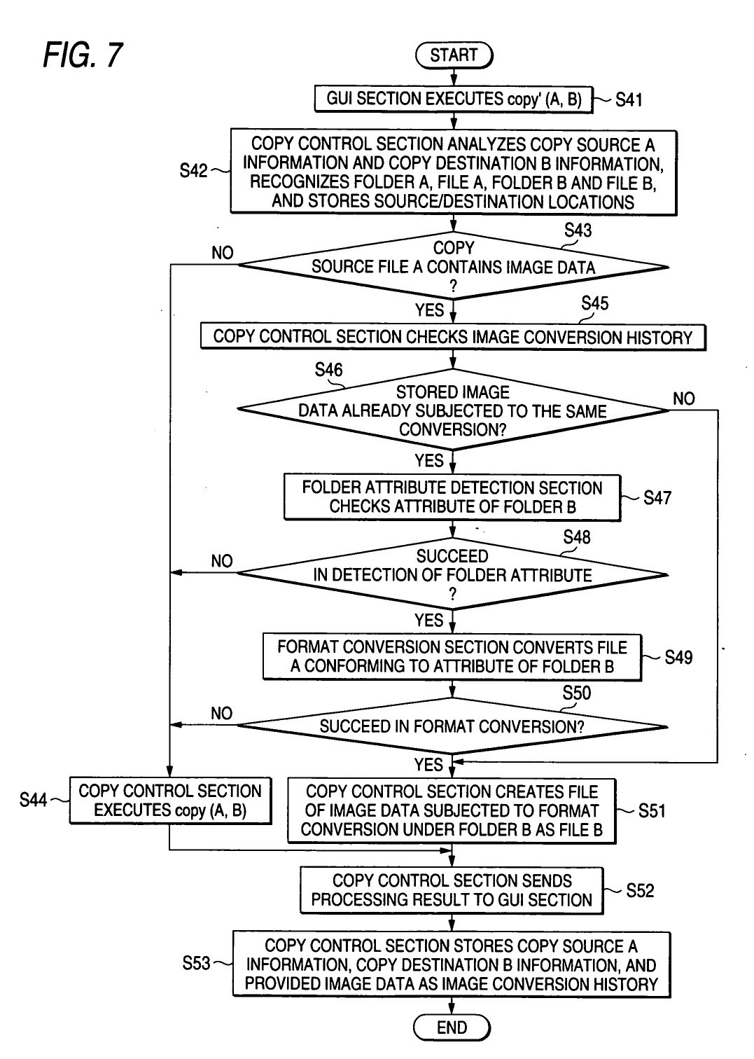

FIG. 7 is a flowchart to show a procedure example of the data conversion apparatus in FIG. 6. The flowchart of FIG. 7 is provided by adding steps S45, S46, and S53, to the flowchart of FIG. 3. The description to follow centers around different process from FIG. 3.

When a conversion result is input from the format conversion section 4, the copy control section 5 copies a file B containing image data after subjected to conversion into a folder B in the storage unit 2 as at step S9 in FIG. 3.

Upon completion of the image conversion of the file B, the history information storage control section 8 in the copy control section 5 stores combined information of information on “copy source A” and “copy destination B” and the image data provided by the format conversion section 4 in the history information storage section 7 as history information. Time for the history information storage section 7 to hold the stored history information may be a limited time period such as the time until the power of the PC is turned off, for example.

Then, when a GUI section 1 executes the same copy function, the copy control section 5 reads necessary image data from the history information storage section 7 and performs a copy process. Accordingly, it becomes possible to copy the file B without using a folder attribute detection section 3 or the format conversion section 4.

Thus, in the third embodiment, the format conversion history information and the image data subjected to the format conversion are previously stored, so that to execute the same copy function, a duplicate process by the folder attribute detection section 3 and the format conversion section 4 is eliminated, a process load can be lightened, and the copy process can be speeded up.

### Fourth Embodiment

In a fourth embodiment of the invention, format conversion is executed after image data is copied to a folder specified by the user.

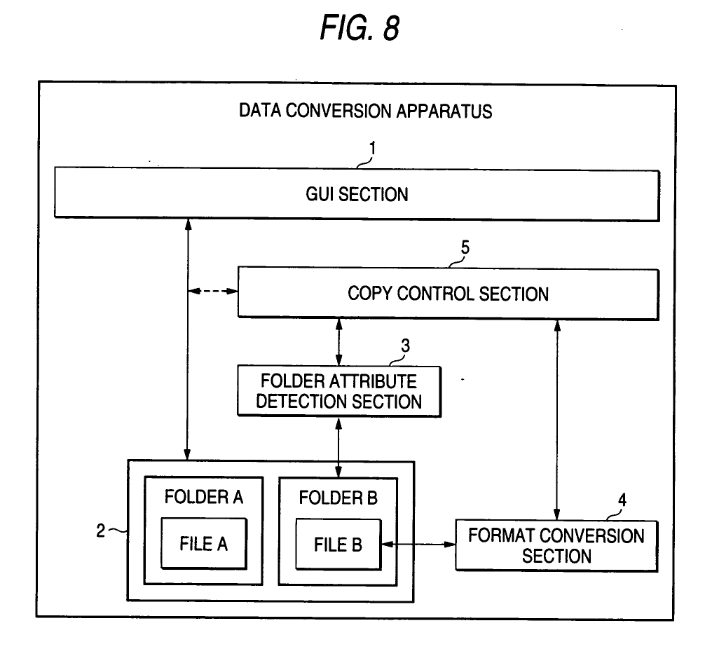

FIG. 8 is a block diagram to show a schematic configuration of a data conversion apparatus according to the fourth embodiment of the invention. The data conversion apparatus in FIG. 8 differs from the data conversion apparatus in FIG. 1 in that a format conversion section 4 transfers image data to and from a storage unit 2 and that a GUI section 1 transfers image data to and from the storage unit 2.

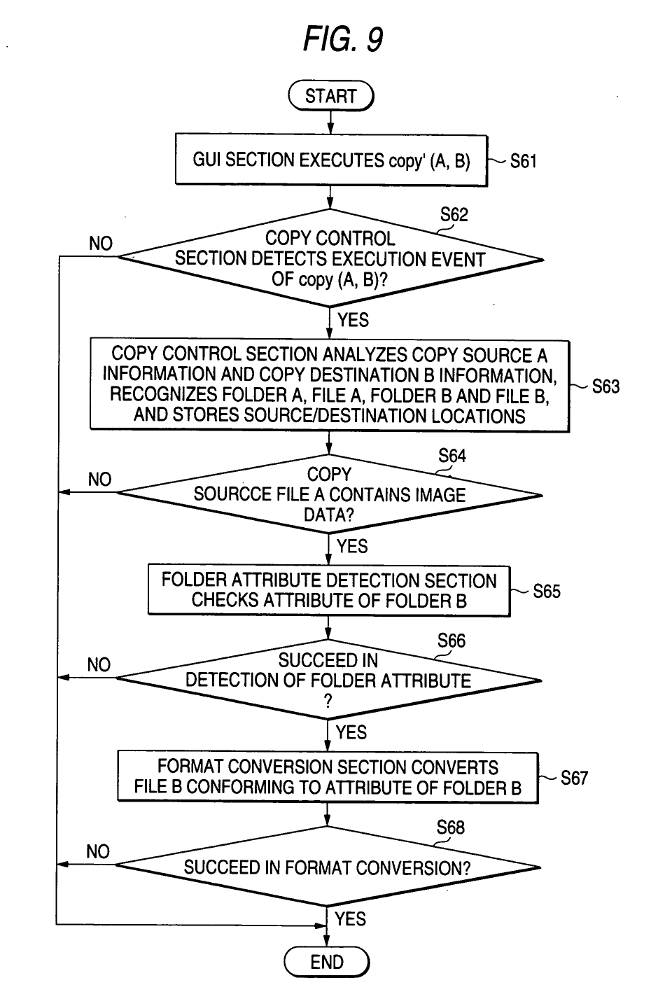

FIG. 9 is a flowchart to show a procedure example of the data conversion apparatus in FIG. 8. In the first to third embodiments, when the user gives a copy command in a drag-and-drop manner, copy′ (A, B) function is executed. In the fourth embodiment, copy(A, B) function similar to that in the related art is used (step S61).

A copy control section 5 has a function of detecting a process event executed in the data conversion apparatus and can detect the GUI section 1 executing copy(copy source A, copy destination B).

Upon detection of a copy process event copy(copy source A, copy destination B) (step S62), the copy control section 5 checks values of “copy source A” and “copy destination B” and stores the values (step S63).

For “copy source A”, it is detected whether or not a file A containing copy source data is a file containing image data (step S64). For “copy destination B”, the file name, file B, created at the copy destination, and the copy destination folder name, folder B, under which the file is created, are separately detected, and detected information of folder B is input to a folder attribute detection section 3.

When the information concerning “copy destination B”, folder B, is input from the copy control section 5, the folder attribute detection section 3 detects an attribute of the folder (step S65).

Next, it is determined whether or not the detection of the folder attribute has been succeeded (step S66). If it has been succeeded, the format conversion section 4 converts the file B conforming to the attribute of the folder B (step S67)

To use a pixel size of height and width of an image as a specific example of the attribute concerning a format of image data, for example, the folder attribute detection section 3 outputs information of “pixel size: 640×480” to the copy control section 5.

In the embodiment, for the attribute concerning the format of image data added to the folder, the folder name is checked and if the folder name is described in a predetermined form representing the pixel size, for example, like “640_{—}480” the attribute concerning the image data format can be detected.

When the attribute concerning the image data format is input from the folder attribute detection section 3, the copy control section 5 inputs information on “copy destination B” and the attribute concerning the image data format to the format conversion section 4.

When the information on “copy destination B” and the attribute concerning the image data format are input from the copy control section 5, the format conversion section 4 converts the file B of “copy destination B” in accordance with the input attribute values as the image data format (step S68).

For example, if the file B contains image data of 1600 pixels×1200 pixels and the attribute value “pixel size: 640×480” is input, the pixel size of the file B is converted into 640 pixels×480 pixels.

For the image format conversion process, an image format conversion function provided by the OS or an additional library may be used or an image format conversion function may be built in the format conversion section 4, but the image format conversion process is not an essence of the invention and therefore details of specific process, etc., will be omitted.

The format conversion section 4 creates a file of the image data after subjected to the format conversion in the folder B of “copy destination B” as a new file B.

On the other hand, if an execution event of copy (A, B) is not detected at step S62, if it is determined at step S64 that the copy source file A does not contain image data, or if the detection of the folder attribute at step S66 has been failed, no process is performed.

The copy control section 5 detects a copy process event copy(copy source A, copy destination B) at step S62, but may check the storage unit 2 for state change at all times and may detect a new file being created in the storage unit 2. In this case, at step S63, only the value of “copy destination B” may be checked and stored instead of checking and storing the values of “copy source A” and “copy destination B”. Then, at step S64, it is determined whether or not the file B contains image data instead of determining whether or not the file A containing copy source data contains image data.

Thus, in the fourth embodiment, the image data can be converted and copied in the format fitted for the attribute of the copy destination folder while the user is not aware of the format conversion as in the first embodiment. Since the format conversion is executed after data is once stored in the storage unit, the copy operation can be performed at higher speed than that in the first embodiment.

### Fifth Embodiment

A fifth embodiment of the invention is intended for enabling the user to specify the format of image data arbitrarily for any folder.

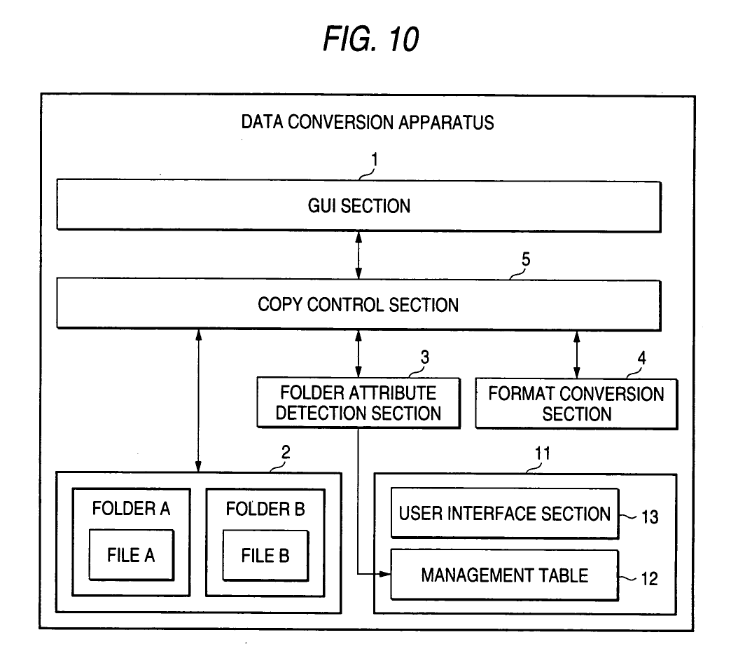

FIG. 10 is a block diagram to show a schematic configuration of a data conversion apparatus according to the fifth embodiment of the invention. A component identical with or similar to that previously described with reference to FIG. 1 is denoted by the same reference numeral in FIG. 10 and the description to follow centers around the differences between the first and fifth embodiments.

The data conversion apparatus in FIG. 10 is provided by adding a folder attribute management section 11 to the configuration in FIG. 1. The folder attribute management section 11 has a management table 12 for managing an image format attribute of each folder and a user interface section 13 for the user to change and set the image format attribute of the folder.

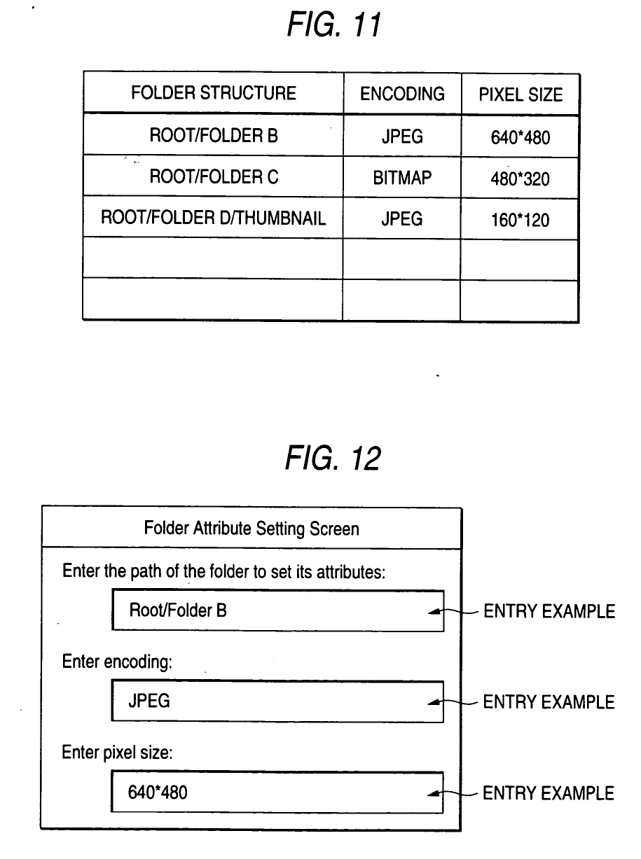

The folder attribute management section 11 uses the management table 12 shown in FIG. 11, for example, as a method of storing and managing the image format attribute added to each folder. The management table 12 in FIG. 11 can store folder information, an encoding and a pixel size associated with the folder. The folder information also contains path information from the root folder and a folder name.

Next, a process operation of the data conversion apparatus of the fifth embodiment will be discussed centering around a difference from the first to fourth embodiments.

When information concerning “copy destination B”, folder B, is input from a copy control section 5, a folder attribute detection section 3 refers to the management table 12 in the folder attribute management section 11. The folder attribute detection section 3 checks whether or not folder information matching “copy destination B” is described in the management table 12. If the folder information is described, an associated encoding and pixel size are output to the copy control section 5 as an attribute concerning the folder format. If the folder information is not described, an error result is output to the copy control section 5.

FIG. 12 is a drawing to show an example of the user interface to set an attribute of a folder provided by the folder attribute management section 11 for the user. On the user interface in FIG. 12 the user can describe folder information, an encoding and pixel size associated with the folder, and values set by the user are reflected in the management table 12 for storage and management.

In the embodiment, the example wherein the folder attribute management section 11 uses the management table 12 to manage the attributes of the folders has been described, but the OS may be provided with a function of the folder attribute management section 11 for storing and managing the image format information in each folder. In this case, the OS may also provide the user interface to set the attribute of the folder.

Thus, in the fifth embodiment, the user can set the attribute concerning the image data format arbitrarily for any folder. Thus, when the file copy operation is performed using the graphical user interface, if the file to be copied contains image data and the format attribute of the image data is set in the copy destination folder, the file can be automatically converted into the image format desired by the user and retained in the copy destination, then the user needs not execute the format conversion by himself.

### Sixth Embodiment

A sixth embodiment of the invention is intended for the user to perform a file copy operation to any other machine connected to a network.

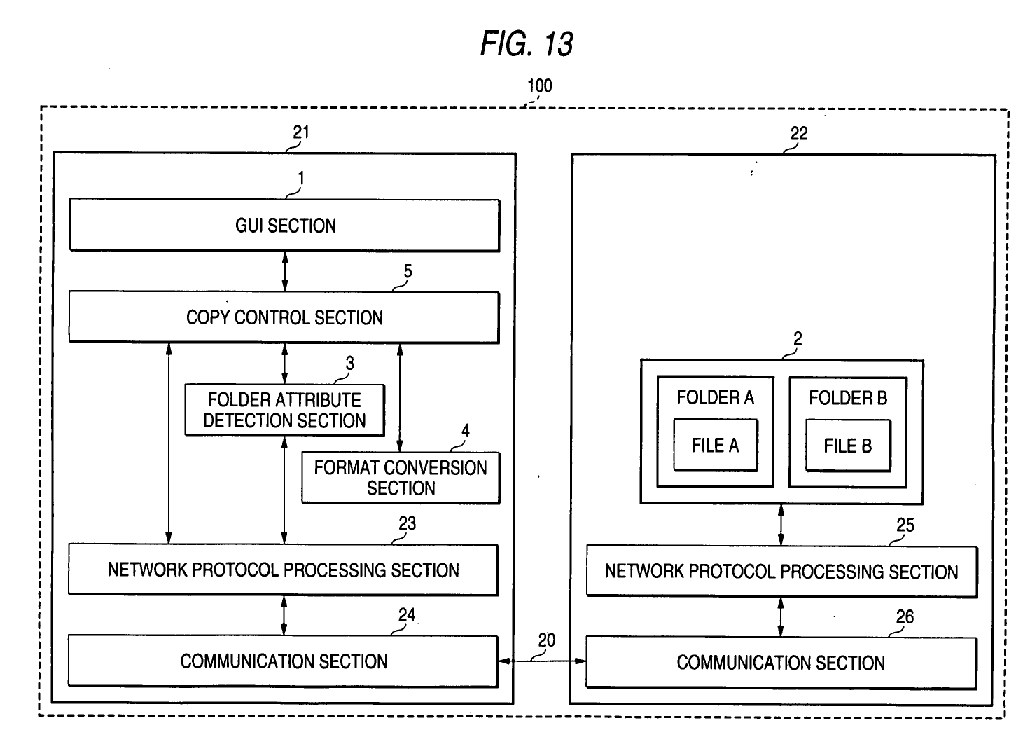

FIG. 13 is a block diagram to show a schematic configuration of a data conversion system according to the sixth embodiment of the invention. A data conversion system 100 in FIG. 13 includes an electronic information control unit 21 and electronic information storage unit 22 connected to a network 20. The electronic information control unit 21 performs storage control of the electronic information storage unit 22. The network 20 may be wired or may be wireless.

The electronic information control unit 21 has a GUI section 1, a copy control section 5, a folder attribute detection section 3, and a format conversion section 4 like those in FIG. 1, and also has a network protocol process section 23 and a communication section 24.

The electronic information storage unit 22 has a storage unit 2 like that in FIG. 1 for storing image data, and also has a network protocol process section 25 and a communication section 26. Assuming an ordinary PC, for example, as the electronic information storage unit 22, the storage unit 2 is an internal hard disk, an external hard disk, a memory card, etc.

The folder attribute detection section 3 of the electronic information control unit 21 can detect an attribute of a folder existing in the storage unit 2 of the electronic information storage unit 22 connected to the network 20.

For example, a function to obtain a folder name in a machine connected to the network 20 is already installed in a PC, etc., as a standard communication protocol, and such a known function is used. The folder attribute detection section 3 of the electronic information control unit 21 checks a folder name existing in the storage unit 2 of the electronic information storage unit 22. If the folder name is described in a predetermined form so as to represent a pixel size, for example, like “640_{—}480,” the folder attribute detection section 3 can detect the attribute concerning the image data format.

The data conversion system 100 in FIG. 13 is the same as the data conversion apparatus in FIG. 1 except that the network 20 is used to exchange information between the copy control section 5 and the storage unit 2 and between the folder attribute detection section 3 and the storage unit 2 in information exchange such as data exchange and control signal exchange between the components.

The electronic information control unit 21 may contain the data conversion apparatus in FIG. 1. In this case, any storage unit of the electronic information control unit 21 and the electronic information storage unit 22 may be used for information on “copy source A” and information on “copy destination B”. For example, it is also possible to adopt a combination such that “copy source A” is a storage area of the electronic information storage unit 22 and “copy destination B” is a storage area of the electronic information control unit 21.

Thus, in the sixth embodiment, when the user uses the graphical user interface to perform the file copy operation to any other machine connected to the network 20, if the file to be copied contains image data and the format attribute of the image data is set in the copy destination folder, the file is automatically converted into the set image format and retained in the copy destination.

### Seventh Embodiment

A seventh embodiment of the invention is a modification of the sixth embodiment, wherein a configuration involved in the copy control is provided in the electronic information storage unit 22.

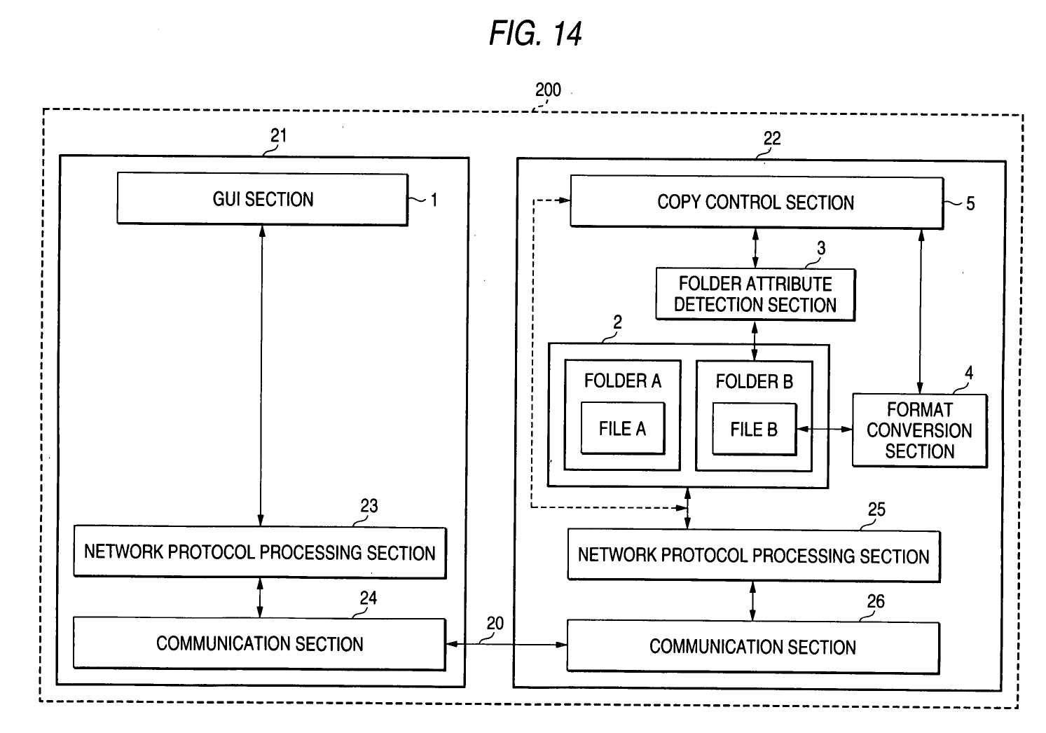

FIG. 14 is a block diagram to show a schematic configuration of a data conversion system according to the seventh embodiment of the invention. The data conversion system 200 in FIG. 14 includes an electronic information control unit 21 and an electronic information storage unit 22 as in FIG. 13. The electronic information control unit 21 has a GUI section 1, a network protocol process section 23, and a communication section 24. The electronic information storage unit 22 has a copy control section 5, a folder attribute detection section 3, a format conversion section 4, a network protocol process section 25, and a communication section 26.

An operation of each component in the data conversion system 200 in FIG. 14, compared with the data conversion apparatus in FIG. 8, is unchanged except that a network 20 is used to exchange information between the GUI control section 1 and storage unit 2 in information exchange, such as a data exchange and a control signal exchange between the components.

In the data conversion system 200 in FIG. 14, when the GUI section 1 executes a copy function, a copy command signal is transmitted through the network 20 to the electronic information storage unit 22, and a copy process is performed in the electronic information storage unit 22. The copy process itself is executed according to a flowchart similar to that of FIG. 9.

Thus, in the seventh embodiment, the copy process is performed in the electronic information storage unit 22 connected via the network 20 to the electronic information control unit 21 checked on display and operated by the user, so that the electronic information control unit 21 can be miniaturized and can be implemented as a PDA, a mobile telephone, etc.

### ADVANTAGES OF THE INVENTION

As described above in detail, according to the invention, the format of the electronic data to be stored is automatically converted so as to be fitted for the attributes of the electronic data storage unit configured to store the electronic data, so that the format conversion of the electronic data can be executed while the user is not aware of the format conversion, the user can be saved from having to execute the format conversion, and an operability is enhanced. A fear of erroneously storing electronic data in a different format in the electronic data storage unit with an attribute specification is also eliminated.

Having now described a few embodiments of the invention, it should be apparent to those skilled in the art that the foregoing is merely illustrative and not limiting, having been presented by way of example only. For example, files are not limited to image file, i.e., sound files as well as moving picture files can also be treated. Numerous modifications and other embodiments are within the scope of one of ordinary skill in the art and are contemplated as falling within the scope of the invention as defined by the appended claims.

What is claimed is:

1. A data conversion apparatus comprising:
a plurality of electronic data storage units, each of which stores electronic data having a proper attribute;
a storage command unit configured to instruct to store electronic data to be stored in one of the plurality of electronic data storage units;
an attribute detection unit configured to detect an attribute of the electronic data to be stored in the electronic data storage unit, the attribute being instructed by the storage command unit configured to be preassigned to the electronic data storage unit as a storage destination;
a format conversion unit configured to convert a format of the electronic data to be stored so as to fit a format for the attribute detected by the attribute detection unit if the attribute of the electronic data to be stored differs from the attribute detected by the attribute detection unit; and
a storage control unit configured to store the electronic data converted by the format conversion unit in the electronic data storage unit as the storage destination.

2. The data conversion apparatus as claimed in claim 1 further comprising:
an attribute registration unit with which attribute information of each of the plurality of electronic data storage units registers; and
a conversion determination unit configured to determine whether or not the electronic data to be stored can be converted by the format conversion unit based on the attribute information registered in the attribute registration unit;
wherein if the electronic data to be stored can be determined to be converted by the format conversion unit, respective processes of the attribute detection unit, the format conversion unit, and the storage control unit are executed.

3. The data conversion apparatus as claimed in claim 2 further comprising:
an attribute detection determination unit configured to determine whether or not the attribute detection unit can detect the attribute assigned to the electronic data storage unit;
wherein the data storage unit is a storage destination of the electronic data; and
if the attribute can be determined to be detected by the attribute detection determination unit, respective processes of the format conversion unit and the storage control unit are executed.

4. The data conversion apparatus as claimed in claim 1 further comprising:
a post-conversion data storage unit configured to store the electronic data converted by the format conversion unit; and
a conversion completion determination unit configured to determine that the electronic data to be stored is already subjected to a conversion, if the electronic data after the conversion is already stored in the post-conversion data storage unit;
wherein the conversion is instructed by the storage command unit configured to correspond to the electronic data to be stored; and
if the conversion completion determination unit determines that the electronic data is already subjected to the conversion, the format conversion unit reads the electronic data corresponding to the electronic data from the post-conversion data storage unit and adopts the read electronic data as the electronic data after conversion.

5. The data conversion apparatus as claimed in claim 2 further comprising:
a post-conversion data storage unit configured to store the electronic data converted by the format conversion unit; and
a conversion completion determination unit configured to determine that the electronic data to be stored is already subjected to a conversion, if the electronic data after the conversion is already stored in the post-conversion data storage unit;
wherein the conversion is instructed by the storage command unit configured to correspond to the electronic data to be stored; and
if the conversion completion determination unit determines that the electronic data is already subjected to the conversion, the format conversion unit reads the electronic data corresponding to the electronic data from the post-conversion data storage unit and adopts the read electronic data as the electronic data after conversion.

6. The data conversion apparatus as claimed in claim 3 further comprising:
a post-conversion data storage unit configured to store the electronic data converted by the format conversion unit; and
a conversion completion determination unit configured to determine that the electronic data to be stored is already subjected to a conversion, if the electronic data after the conversion is already stored in the post-conversion data storage unit;
wherein the conversion is instructed by the storage command unit configured to correspond to the electronic data to be stored; and
if the conversion completion determination unit determines that the electronic data is already subjected to the conversion, the format conversion unit reads the electronic data corresponding to the electronic data from the post-conversion data storage unit and adopts the read electronic data as the electronic data after conversion.

7. A data conversion apparatus comprising:
a plurality of electronic data storage units, each of which stores electronic data having a proper attribute;
a storage command unit configured to instruct to store electronic data to be stored in one of the plurality of electronic data storage units;
a storage control unit configured to store the electronic data instructed by the storage command unit in the electronic data storage unit as the storage destination;
an attribute detection unit configured to detect an attribute of the electronic data to be stored in the specific electronic data storage unit storing the electronic data, the attribute being instructed by the storage command unit configured to be preassigned to the electronic data storage unit; and
a format conversion unit configured to convert the electronic data to be stored in accordance with the attribute detected by the attribute detection unit and the command given by the storage command unit.

8. The data conversion apparatus as claimed in claim 1,
wherein the electronic data is image data; and
the format conversion unit converts a format having at least one of a type of image data, a resolution of image data, height and width of image data, a number of colors of image data, and an encoding of image data.

9. The data conversion apparatus as claimed in claim 7,
wherein the electronic data is image data; and
the format conversion unit converts a format having at least one of a type of image data, a resolution of image data, height and width of image data; a number of colors of image data, and an encoding of image data.

10. A data conversion apparatus comprising:
a plurality of electronic data storage units, each of which stores electronic data having a proper attribute;
a storage command unit configured to instruct to store electronic data to be stored in one of the plurality of electronic data storage units;
an attribute detection unit configured to detect an attribute of the electronic data to be stored in the electronic data storage unit, the attribute being instructed by the storage command unit configured to be preassigned to the electronic data storage unit as a storage destination;
a format conversion unit configured to convert a format of the electronic data to be stored so as to fit a format for the attribute detected by the attribute detection unit if the attribute of the electronic data to be stored differs from the attribute detected by the attribute detection unit; and
a storage control unit configured to store the electronic data converted by the format conversion unit in the electronic data storage unit as the storage destination;
wherein the electronic data storage unit is a folder or a directory logically created by an operating system.

11. The data conversion apparatus as claimed in claim 1 further comprising:
an attribute setting unit configured to set the attribute of each of the plurality of electronic data storage units; and
an attribute information storage unit configured to store the attribute set by the attribute setting unit in association with the electronic data storage unit, wherein
the attribute detection unit detects the attribute of the electronic data storage unit as the storage destination in accordance with a content stored in the attribute information storage unit.

12. The data conversion apparatus as claimed in claim 7 further comprising:
an attribute setting unit configured to set the attribute of each of the plurality of electronic data storage units; and
an attribute information storage unit configured to store the attribute set by the attribute setting unit in association with the electronic data storage unit, wherein
the attribute detection unit detects the attribute of the electronic data storage unit as the storage destination in accordance with a content stored in the attribute information storage unit.

13. The data conversion apparatus as claimed in claim 10 further comprising:
an attribute setting unit configured to set the attribute of each of the plurality of electronic data storage units; and
an attribute information storage unit configured to store the attribute set by the attribute setting unit in association with the electronic data storage unit, wherein
the attribute detection unit detects the attribute of the electronic data storage unit as the storage destination in accordance with a content stored in the attribute information storage unit.

14. A data conversion program comprising:
instructing to store electronic data to be stored in one of a plurality of electronic data storage units each of which stores electronic data having a proper attribute;
detecting an attribute of the electronic data to be stored in the electronic data storage unit, the attribute being instructed to be preassigned to the electronic data storage unit as a storage destination;
converting a format of the electronic data to be stored to fit a format for the detected attribute if the attribute of the electronic data to be stored differs from the detected attribute; and
storing the electronic data subjected to the conversion in the electronic data storage unit as the storage destination.

15. The data conversion program as claimed in claim 14 further comprising:
registering attribute information of each of the plurality of electronic data storage units; and
determining whether or not the electronic data to be stored can be converted based on the attribute information;
wherein if the electronic data to be stored can be determined to be converted, the attribute is detected, the format is converted, and the electronic data is stored.

16. The data conversion program as claimed in claim 15 further comprising:
determining whether or not the attribute assigned to the electronic data storage unit can be detected;
wherein the data storage unit is a storage destination of the electronic data; and
if the attribute can be determined to be detected, the format is converted and the electronic data is stored.

17. The data conversion program as claimed in claim 14 further comprising:
storing the converted electronic data in a post-conversion data storage unit; and
determining that the electronic data to be stored is already subjected to a conversion, if the electronic data after the conversion is already stored in the post-conversion data storage unit;
wherein the conversion is instructed to correspond to the electronic data to be stored; and
if the electronic data is already determined to be subjected to the conversion, the electronic data corresponding to the electronic data is read and the electronic data read from the post-conversion data storage unit is adopted as the electronic data after conversion.

18. A data conversion program comprising:
instructing to store electronic data to be stored in one of a plurality of electronic data storage units each of which stores electronic data having a proper attribute;
storing the instructed electronic data in the electronic data storage unit as a storage destination;
detecting an attribute of the electronic data to be stored in the specific electronic data storage unit, the attribute being preassigned to the electronic data storage unit storing the instructed electronic data; and
converting the electronic data to be stored in accordance with the detected attribute and the instruction.

19. The data conversion program as claimed in claim 18,
wherein the electronic data is image data; and
the format to be converted includes at least one of a type of image data, a resolution of image data, height and width of image data, a number of colors of image data, and an encoding of image data.
